(19) United States
(12) Patent Application Publication
(10) Pub. No.: US 2020/0214489 A1
(43) Pub. Date: Jul. 9, 2020

(54) Soxer

(71) Applicants: Jeffrey Milo Merriam, St. Clair Shores, MI (US); Kimberly Elizabeth Gallagher, St. Clair Shores, MI (US)

(72) Inventors: Jeffrey Milo Merriam, St. Clair Shores, MI (US); Kimberly Elizabeth Gallagher, St. Clair Shores, MI (US)

(21) Appl. No.: 16/242,221

(22) Filed: Jan. 8, 2019

(51) Int. Cl. A47G 25/90; A01K 13/00

(52) U.S. Cl. CPC A47G 25/905; A01K 13/007

(57) ABSTRACT

The soxer holds a stretched sock so you can seat the dog's paw into the sock to eliminate nails and dew claws catching in the material of the sock. Once the paw is seated the soxer rolls up the leg to give the sock a perfect fit around your dog's leg. The soxer makes putting on the socks a one-person job.

With icy streets, snow-covered sidewalks and a lot of salt scattered on the ground, our pet boutique has an increased demand from our customers for something to protect their dog's paws. We had an elderly customer that came into our store and needed something to protect her dog's paws. She had tried boots in the past however her dog never adjusted to the way they fit. I explained that boots are hard to put on and they don't work unless they are a perfect fit. We tried to put socks on her dog which didn't work because her dog won't still and her nails kept getting snagged as we tried to slip the sock onto her foot. After this failed attempt to help our customer's dog I figured that there must be an easier way. I needed to invent a device that would help a person get four socks on their dog quickly.

### BRIEF DESCRIPTION

My invention of the Soxer is comprised of a set of four cylinder-shaped devices that easily help you place the socks on your dog's paw see

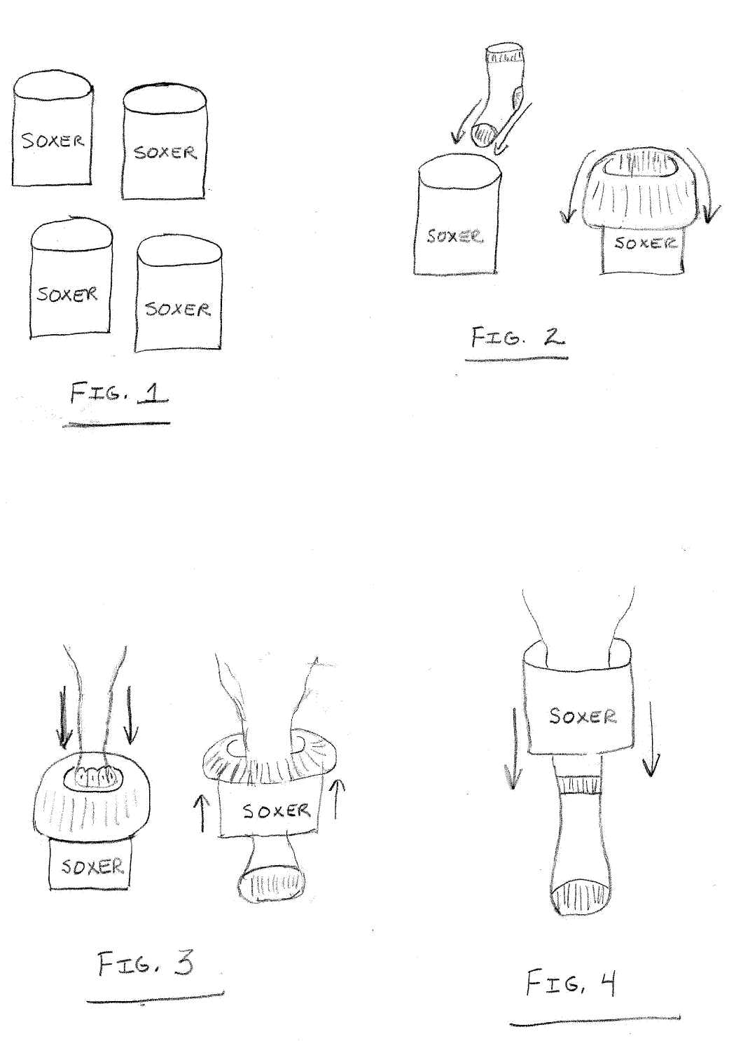

FIG. 1. You simply insert the sock, toe first into one of the Soxers and roll the top part of the sock down the sides of the cylinder so that the toe of the sock remains inside the cylinder and is not protruding from the bottom. Repeat this process with each Soxer so all four have socks inserted and are ready to go.

FIG. 2. Holding one of the sock-loaded Soxers in one hand, guide the dog's paw into the Soxer, making sure the toe is snug and fully seated at the bottom of the sock. Once the toe is seated, glide the Soxer up the dog's leg, allowing the sock to unroll from the tube and cover the dog's paw and leg

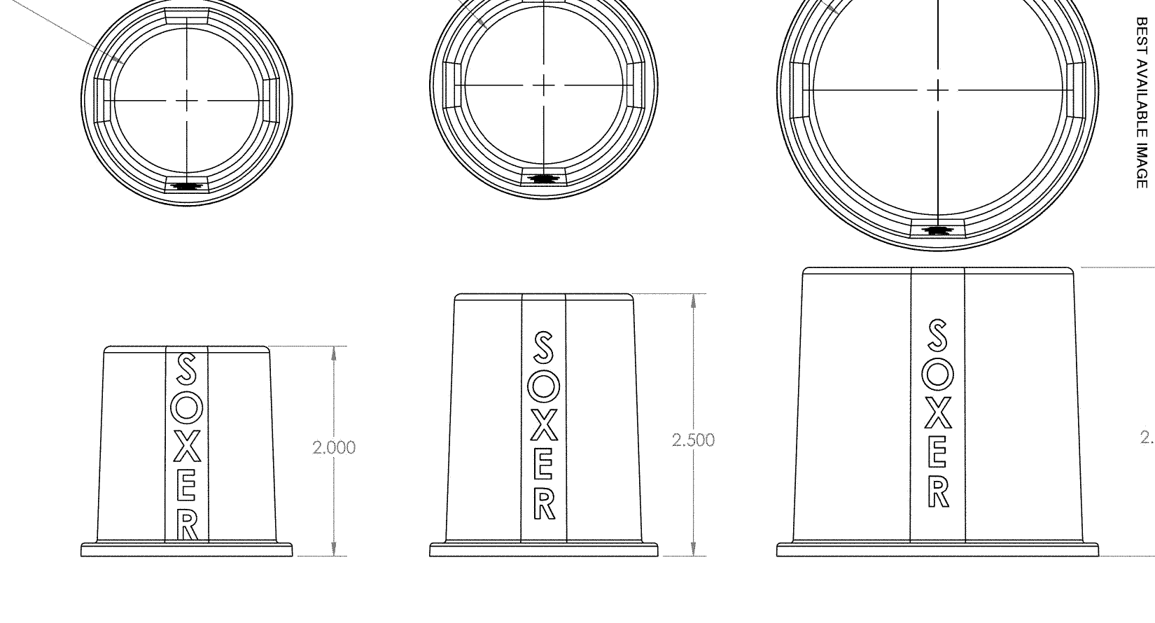

FIG. 3. To finish up just slide the empty Soxer off the dog's leg and repeat with the remaining paws

FIG. 4. It's quick easy and only takes 15 to 20 seconds to place all four socks on your dog with no help from a second set of hands this has been very helpful for especially elderly people.

1: The soxer stretches and holds a sock in position while sliding the dog's paw into the sock.

2: The soxer keeps the sock stretched while sliding the sock up the dog's leg which eliminates catching any dew claws in the material of the sock. (See FIG. 3)

3: Keeping the sock stretched while rolling it up the dog's leg provides a snug and perfect fit against the dog's leg and paw.

4: Using the soxer makes the task of putting socks on a dog a one-person task.
